(19) United States
(12) Patent Application Publication
(10) Pub. No.: US 2009/0234857 A1
(43) Pub. Date: Sep. 17, 2009

(54) Controllable Content Distributing System

(76) Inventors: Eric Barault, Perros Guirec (FR); Nicolas Bihannic, Lannion (FR); Armand Vandenbussche, Lannion (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/086,268

(22) PCT Filed: Dec. 8, 2006
(86) PCT No.: PCT/FR2006/051322

§ 371 Date: Jun. 6, 2008

(30) Foreign Application Priority Data
Dec. 13, 2005 (FR) 0553859

(51) Int. Cl. G06F 17/30

(52) U.S. Cl. 707/9; 707/200; 707/E17.005; 707/E17.044

(57) ABSTRACT

A system for controlled distribution of access to and broadcasting of a content acquired by a user from a content provider and accessible through an access provider, said system comprising a content control provider able to receive from said content provider and to store in a centralized database data relating to the user's rights over the acquired content. The access provider comprises a local database able to receive from said content control provider said data relating to the user's rights and a decisionmaking device able to analyze streams sent out by said user and to decide if said streams sent out conform to the user's rights registered in said local database. Application to controlling access to multimedia contents and broadcasting thereof to users when on the move or away from home via a number of types of networks or to users simultaneously connected to a number of types of networks.

A system for controlled distribution of contents acquired by users from content providers and accessed via access providers.

The invention finds a particularly advantageous application to controlling access to and broadcasting of multimedia contents to users who can be simultaneously connected to more than one type of network, in particular when they are on the move or away from home, i.e. using mobile communications equipment or roaming in the broad sense of using fixed equipment associated with a third party.

The invention therefore aims to guarantee multimedia content providers that their contents will not be broadcast illicitly over a telecommunications network. It also enables end users to control access by people around them, for example to undesirable content.

Moreover, the system of the invention is designed so that users benefit from the flexibility of telecommunications networks. Users can therefore use different access networks, such as a mobile network, in particular a GPRS network, a wireless local area network (WLAN), or a fixed high bit rate xDSL network, to access their contents and/or to broadcast them in compliance with rights acquired from multimedia content providers. In this context, the system of the invention enables users to access and to broadcast their contents even if they are on the move or away from home and therefore do not have access to the telecommunications network via a line in their name.

Driven by sustained expansion of the penetration of high bit rate Internet connections, the exponential integration of digital communications into everyday life has caused a step change in consumption habits. With the explosion of on-line selling of multimedia contents, protecting authors' rights is more than ever a major requirement of content providers.

Furthermore, end users are nowadays experiencing a greater requirement for testing against their expectations the integrity and the conformity of data reaching them, and also for controlling the perimeter over which their personal data is broadcast.

Moreover, in an information technology universe that is diverse in terms of varied architectures, such as client/server architectures and peer to peer architectures, controlling broadcast contents and protecting the user is a requirement in a non-home environment in which users are offered a multitude of channels (GPRS, xDSL, etc.) giving access to their usual resources.

In this context, solutions to all these concerns must:
preserve the generation of values around the broadcasting multimedia contents over the Internet;
enable users to access their data from any access network and in accordance with their rights over such data;
guarantee the integrity of data received by users and its conformance to their expectations;
protect clients' personal data from abusive broadcasting.

In this perspective, many information encryption techniques and associated transfer techniques are now available, but they do not integrate all of the requirements of a complex environment in which users seek to obtain the benefit of their contents or to offer to others the benefit of those contents over a plurality of networks.

Of those mechanisms, the Open Mobile Alliance (OMA), an industry forum created in 2002, specifies techniques based on digital rights management (DRM) to regulate the transport of contents, but only in mobile networks. Those mechanisms can take a number of different forms, namely:
the Forward-Lock method of blocking any transfer of a received message;
the Combined Delivery method of creating a DRM message that associates a content with the rules that apply to it; and
the Separate Delivery method, whereby the content and the associated usage rules are no longer transmitted in the same DRM message. That mechanism identifies two pertinent applications: firstly, modifying a user's right to use a given media content, with no necessity to return it, and, secondly, sharing a multimedia content between a number of users who can then be assigned particular rights, specifically because the rights and the content are not carried in the same message.

In contrast to these techniques based on encryption, French patent application No. 04 51981 associates:
personalizing contents by marking with a watermark specific to a given acquisition, grouping data relating to the content acquired, to acquisition as such, and to the user, in particular the user's rights to the acquired content;
detecting contents marked in this way by providers of access to the network that transports the multimedia contents;
analyzing the legitimacy of transferring streams sent by users by means of requests submitted by access providers to a centralized database managed by a content control provider; and
notifying content providers of anomalies encountered between the contents analyzed and the associated rights.

US patent application No. 2002/0186844 can also be mentioned, and proposes:
personalizing delivered contents by marking with a watermark completely characterizing the distribution context;
using a set of databases to group all of the rights to the marked content of those involved in distribution (distributors' rights, operators' rights, vendors' rights, end users' rights);
equipment located on the end user premises detecting marked contents during playback of the content by the end user; and
verifying by a centralized method the rights of the end user over the content when playing it back.

However, those known controlled content distribution systems have a number of drawbacks.

For mechanisms based on the OMA:
The OMA imposes heavy constraints on hardware and in particular on the mobile terminal that processes the DRM message. Re-use of the data is difficult to envisage because of the intrinsic architecture, with the result that the portability of that solution to other terminals remains a problem, especially in an environment of fixed networks.
Setting up a closed model specific to mobile networks can prove prejudicial to content providers. Users will find more attractive a solution that federates several of the technologies of their environment. A direct consequence would be the selection of a content provider authorizing use of the content in the widest environment in terms of access technologies and situations of use, such as when away from home.
Within the same access technology, the very close link between DRM message creation mechanisms and the possibility of execution by the terminal entails a high risk of incompatibility between the various solutions implemented by content providers and thus reduces accessibility to the contents of portals.
Those mechanisms cannot protect rights associated with users' personal data; only contents sent by content providers can be controlled.
Finally, solutions based only on encryption of the information are of no further interest once the embedded algorithms can be hacked.

The solution described in French patent application No. 04 51981 has the following limitations:
The system cannot integrate heterogeneous marking technologies, only the marking technology proposed by the DRM service provider.
The centralized system hinges on the database of the content control provider. There is a critical ratio between, firstly, the abundance of streams between the analysis devices (also known as probes) and the DRM service provider and, secondly, the heavy constraint of maintaining a short response time to an enquiry from a probe.

The following limitations can be identified in US patent application No. 2002/0186844:
The system detects watermarks only on users' premises, in a specific unit, constraining the end user to use dedicated playback hardware.
The system does not make it possible to detect or to interrupt illicit exchange of content during transfer thereof.
The system does not enable users' rights to be distinguished as a function of the access network used.
The system does not make it possible to detect or to notify a content provider of detection of illicit exchanges of content, so long as said content is not read in the end user's installation.
The system does not enable those involved in the content distribution chain to distance themselves from the complexity of DRM management. Each participant (distributor, operator, vendor, end user) manages a database that contains the user's rights to use content relating to that participant.

Finally, it must also be noted that none of the known systems has the capacity to check the contents received by the end user in order to verify that it conforms to criteria predefined by that user.

Thus the problem to be solved by the subject matter of the present invention is to propose a system for controlled distribution of a content acquired by a user from a content provider and accessible through an access provider, said system comprising a content control provider able to receive data from said content provider and to store it in a centralized database, said data relating to the user's rights over the acquired content, in which system it is possible in particular to accommodate the constraints of an environment including multiple access networks with users desiring to be able to have access to acquired content regardless of the access network used, and also to optimize exchanges between stream analyzer probes and the content control provider so as to shorten the response time to a probe's request about user rights.

According to the present invention, the solution to the technical problem posed consists in that said access provider comprises a local database able to receive from said content control provider said data relating to the user's rights and a decisionmaking device able to analyze streams sent out by said user and to decide whether said streams sent out conform to the user's rights registered in said local database.

Thus, at the same time as respecting the principle of transparency between users and content providers by virtue of the presence of a unique entry point consisting of the content control provider, the controlled distribution system of the invention offers a decentralized architecture obtained by associating a local database with each access provider. Clearly, in this way, the response time to a request from a device for taking decisions as to a user's rights is short because under such circumstances the response to the enquiry emanates from the local database of the access provider concerned and not from the centralized database of the content control provider.

To simplify further the structure of the operational database, i.e. the local database, according to the invention said access provider may provide information to an approved presence function of the content control provider, which information relates to the presence of the user at an access point, and the content control provider may supply to the local database of the access provider the data relating to the rights of said user present at said access point.

This particularly advantageous feature means that the local database needs to be supplied only with data relating to users connected to the access provider with which said local database is associated.

According to the invention, said centralized database may receive data for controlling access to said content, which data is defined by users in conjunction with service providers and in accordance with a profile enabling them to exercise parental control over the contents acquired, for example. At the time of connection of a third party user, said access control data is supplied to the local database of the access provider concerned so that the decisionmaking device, or probe, can verify whether access to the content by said third party user is authorized or not.

Similarly, the invention provides for said centralized database to receive data for controlling broadcasting of an acquired content. In particular, said broadcasting control data consists of marking characteristics of said acquired content.

The invention also provides a content control provider in a system for controlled distribution of a content acquired by a user from a content provider, noteworthy in that said content control provider can supply a local database of an access provider of the user with data relating to the user's rights over the content acquired.

According to the invention, said content control provider can receive from said access provider information about the presence of the user at an access point and supply to the local database of said access provider the data relating to the rights of said user present at said access point.

According to the invention, the content control provider can receive data for controlling access to said content and store it in a centralized database.

According to the invention, the content control provider can receive data for controlling broadcasting of said content and store it in a centralized database.

The invention also provides an access provider in a system for controlled distribution of a content acquired by a user from a content provider, noteworthy in that said access provider comprises a local database able to store data relating to the user's rights over the acquired content and a decisionmaking device able to analyze streams sent out by said user and to decide if said streams sent out conform to said rights of use of the user.

According to the invention, said access provider can supply information about the presence of the user at an access point to an approved presence function of a content control provider.

The following description with reference to the appended drawings, provided by way of nonlimiting example, explains in what the invention consists and how it can be reduced to practice.

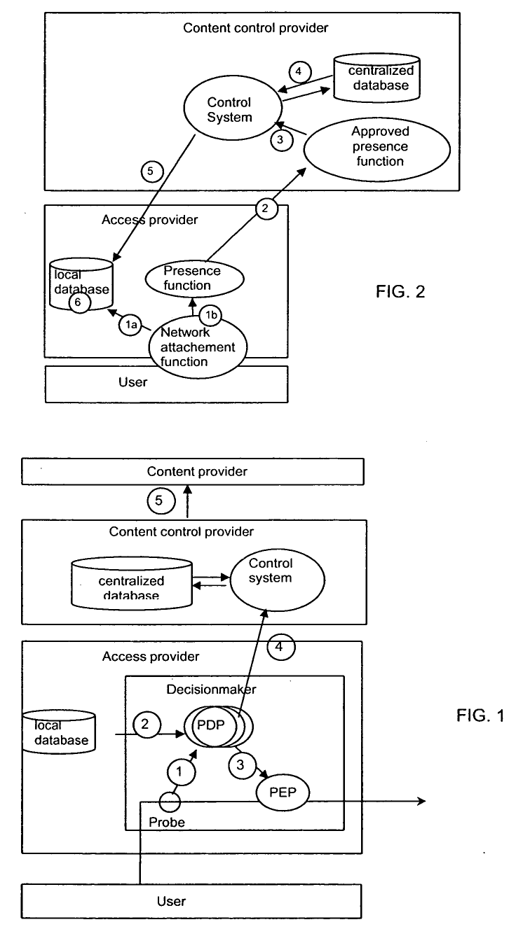

FIG. 1 is a general diagram of a controlled distribution system of the invention.

FIG. 2 is a diagram showing how the local database of an access provider is fed with data.

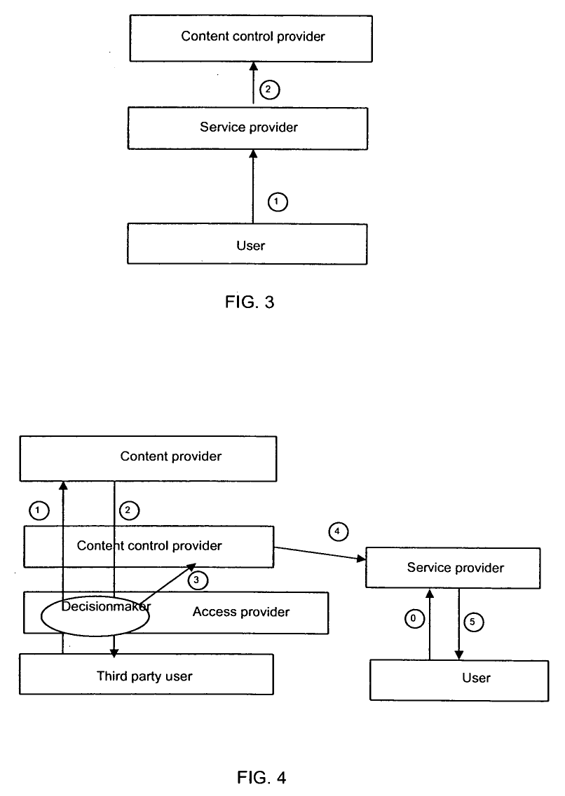

FIG. 3 is a diagram showing how the content control provider for content access control is fed with data.

FIG. 4 is an implementation diagram for content access control.

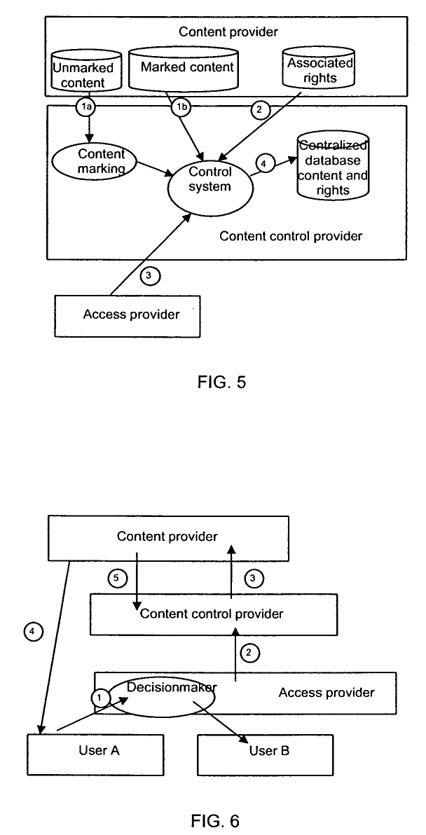

FIG. 5 is a diagram of content marking for content broadcasting control.

FIG. 6 is an implementation diagram for content broadcasting control.

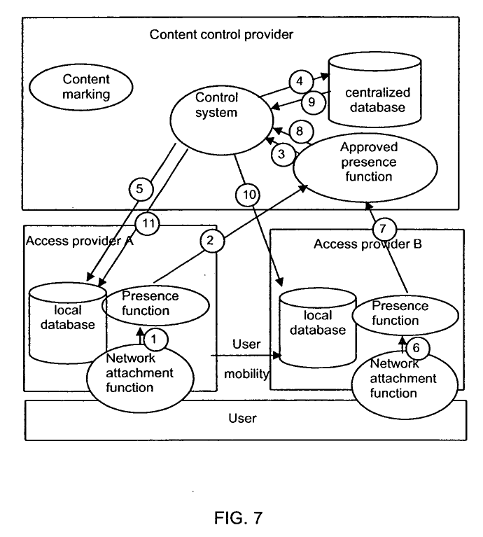

FIG. 7 is a diagram of an application of the system of the invention to a user in situation when on the move or away from home.

FIG. 1 shows a system for controlled distribution of a content, for example a multimedia file, that a user has acquired from a content provider. The user can access this content through at least one access provider, the invention being of particular benefit when the user can access the acquired content via a number of access providers, as becomes clear below in relation to the user being on the move or away from home. The access technologies that can be envisaged here include mobile networks, in particular GPRS networks, wireless local area networks (WLAN), and fixed high bit rate networks such as ADSL networks.

As FIG. 1 shows, the controlled distribution system of the invention comprises a content control provider that itself comprises a control system responsible for exchanging payload data with the content provider and the access provider. That data is stored in a centralized database and relates, firstly to information supplied by the content provider, such as data relating to the acquired content, data relating to the acquirer, in particular an identification of the access network, more precisely the access point of a network, and data relating to the user's rights over the acquired content, including any rights in respect of third parties, and secondly, to information supplied by the access provider, essentially the network identity of the user that will be used in exchanges between the content control provider and the access provider.

It can be seen in FIG. 1 that the access provider comprises a local database which can store information supplied by the content control provider, in particular data relating to the rights of the user, as well as the user's network identity and network identifier, which can be the user's IP address in an IP network. Moreover, the access provider comprises a decisionmaking device able to analyze by means of a probe the streams sent out by the user to decide if those streams conform to the user's rights as recorded in the local database.

One advantage of the local database is that it need contain only information relating to users who are actually connected to the network concerned.

The mechanism for feeding data to the local database offering this advantage is described below with reference to FIG. 2.

The sequence of steps is as follows:

1—The network concerned offers a network attachment function procedure enabling the user to be connected. As soon as attachment to the network has been effected:
1a—the network attachment function informs the local database that a new user has been connected. This database is responsible for matching network information supplied by the network attachment function and information to be supplied in step 5 by the control system of the content control provider. The network data to be stored in the local database at this stage comprises:
the network identity of the user, which is the key to correspondence with step 5;
the network identifier that is the enquiry key of the decisionmaking system during processing of streams sent out by the user;
1b—the network attachment function informs a presence function of the presence of the user identified from their network identity. The data exchanged consists of the user's network identity.
   2—The presence function notifies an approved presence function of the content control provider of the attachment of the user using the user's network identity and network identifier, or network access point identifier, which is extracted from the network identifier. The data exchanged comprises:
the network identity of the user;
the network access point (i.e. network identifier).
   3—The approved presence function, for a given user, approves all their network identities and network locations and notifies the control system of the content control provider of the presence of the user on the access network concerned. The data exchanged comprises:
the user's network identity;
the network access point.
   4—Using this information, the control system recovers from the centralized database all the payload data relating to the characteristics of the content acquired by the user, including the associated rights for the access point concerned and the access rights of the user when controlling access to contents.
   5—The control system sends all this payload data to the local database.
   6—This data is then written into the local database using the network identity of the user as a reference.

If the same user is connected to a second network, the same sequence is executed for that second network.

The decisionmaking mechanism used for controlling streams sent out by users is described below with reference to FIG. 1.

The sequence of steps is as follows:

1—The streams sent out to be processed are directed by a probe to a policy decision point (PDP).
2—The PDP checks with the local database if the network identifier corresponds to a controlled distribution service relating to a user, with the option to retain this result in memory to eliminate the need for subsequent checks relating to the same network identifier.

In the event of a positive outcome, the PDP consults the local database using the network identifier and the characteristics of the stream to be processed. The local database then supplies the rights relating to the service. In a variant of the invention, at the time of the first enquiry relating to this network identifier, the PDP can recover all of the rights, independently of the characteristics of the stream to be processed. The information is then stored, which avoids repetition of step 2 thereafter on processing each stream relating to that network identifier. However, this latter variant makes it obligatory for the local database to use an updating mechanism as soon as information associated with that identifier is modified (characteristics of the stream to be processed and corresponding rights).

3—The PDP informs a policy enforcement point (PEP) of the policy to be applied for the stream sent out by the user.
4—The PDP informs the control system of the event and processing thereof in relation to the user and on the basis of the user's network identity. It should be noted that the user's network identity is part of the data in the local database (step 1a of feeding the local database with data) and was recovered on consulting the local database in step 2.
5—The content control provider is then responsible for notifying processing that concerns users on whose behalf content providers subscribe to distribution control services. It recovers additional information necessary for such notification by consulting the centralized database, the consultation key for the centralized database being the user's network identity.

The content control distribution system that has just been described generically with reference to FIGS. 1 and 2 can be applied to different instantiations, such as controlling access to contents and broadcasting of contents, described in succession below.

One example of access control relates to parental control of access to Web pages. The object is to control Internet sites visited by an identified third party user when they log onto the network. Control can be effected at the time of requesting the page, in the upward direction of the request, or when data is downloaded to the user's terminal.

The content control provider is fed with data as shown in FIG. 3:

1—The user supplies the access control service provider with the control characteristics they wish to exercise. The control characteristics relate to the identity of third party user(s) to which such control is applied.
2—The service provider supplies the control characteristics and the network identity of third party user(s) to the content control provider.

Moreover, at the time of subscribing to the service, the access control service provider must supply the user's identity to the content control provider. The content control provider then matches the user's identity to their network identity.

Access control as such is carried out as shown in FIG. 4.

The step (0) is the data feeding phase that has just been described with reference to FIG. 3, in which the user indicates the control characteristics they wish to see effected. In the present instance the user can be a parent and the third party user a child who logs onto Web pages.

The decisionmaking device is positioned between the user and the content provider, in the access provider. This device analyzes upward streams from the user and downward streams from Web servers. Decisionmaking can be effected either on enquiries from the user (1) or on responses from the Web servers (2).

On detection of an anomaly, at the request of the client, the decisionmaking device can block the stream and/or alert the user. When alerting the user, the access provider sends (3) the information to the content control provider who relays it (4) to the service provider, who routes it (5) to the user.

An application of the controlled distribution system of the invention to broadcasting contents is illustrated by FIGS. 5 and 6.

The object of this application is to assure a content provider that the file they supply to a user is broadcast only in accordance with rights for which the user has paid.

Content broadcasting control is effected by means of a content marking mechanism. Marking applies in particular to data, enabling discrimination of the contents, and the associated rights, in particular the persons authorized to receive the contents.

In this context, the provider of a content can themselves mark (1b) the content or have it marked (1a) by the content control provider or by a third party entity, this operation being effected at the “content marking” level indicated in FIG. 5.

If marking is not effected by the content control provider, the third party entity effecting the marking must know the identity of the user in order to personalize the marking. The marked content is then sent to the content provider for distribution to the user.

After the content provider sends the file, the access provider of the user must first supply (3) the network identity of the user to the content control provider, which can therefore match the service identity of the user and their network identity.

The centralized database is fed with the following information (4) associated with the service identity of the user:
the user's rights associated with each content supplied (2) by each of the content providers;
the personalized marking characteristics;
the user network identity.

Broadcasting as such can be controlled as shown in FIG. 6.

The decisionmaking device is in the access provider between the users A and B.

On detection of an anomaly relating to the right to transfer (1) the content between the two users, this mechanism remaining valid in the event of broadcasting of this content to a number of end users, the decisionmaking device feeds the information back (2) to the content control provider, which forwards it (3) to the content provider. The content provider can inform the acquirer of the content of the anomaly detected (4). If the user A regularizes their rights after the notification step 4, the content provider notifies (5) the content control provider of the modifications to the user profiles.

The FIG. 7 diagram shows how the controlled distribution system as described above is applied with advantage to the situation of a user who is on the move or away from home.

Network mechanisms exploiting the advantages of the presence functions for determining the location of the user make it possible to take account of the user being on the move or away from home.

The initial downloading of information into the local database, corresponding to the network A operated by the access provider A, is effected as described with reference to FIG. 2.

If the user's geographical location changes, and their network access point is modified, the user moving from the network A to the network B operated by the access provider B (remembering that the operator of the network B can be the operator of the network A or some other operator, the invention having a multi-network and multi-operator vocation), then at the time of attachment to the new point of the network B, a cycle is initiated to download information into the new local database, that of the access provider B. This mechanism comprises the steps 6 to 10 that correspond exactly to the steps 1 to 5.

The information of the user contained in the initial local database of the access provider A is not deleted until after a time-delay.

1. A system for controlled distribution of a content acquired by a user from a content provider and accessible through an access provider, said system comprising a content control provider able to receive data from said content provider and to store it in a centralized database, said data relating to the user's rights over the acquired content, wherein said access provider comprises a local database able to receive from said content control provider said data relating to the user's rights and a decisionmaking device able to analyze streams sent out by said user and to decide whether said streams sent out conform to the user's rights registered in said local database.

2. The system according to claim 1, wherein said access provider can provide information to an approved presence function of the content control provider, which information relates to the presence of the user at an access point, and in that the content control provider can supply to the local database of the access provider the data relating to the rights of said user present at said access point.

3. The system according to claim 1, wherein said centralized database can receive data for controlling access to said content.

4. The system according to claim 1, wherein said centralized database can receive data for controlling broadcasting of said content.

5. The system according to claim 4, wherein said broadcast control data comprises marking characteristics of said acquired content.

6. A content control provider in a system for controlled distribution of a content acquired by a user from a content provider, wherein said content control provider can supply a local database of an access provider of the user with data relating to the user's rights over the content acquired.

7. The content control provider according to claim 6, wherein said content control provider can receive from said access provider information about the presence of the user at an access point and to supply to the local database of said access provider the data relating to the rights of said user present at said access point.

8. The content control provider according to claim 6, wherein the content control provider can receive data for controlling access to said content and store such data in a centralized database.

9. The content control provider according to claim 6, wherein the content control provider can receive data for controlling broadcasting of said content and store such data in a centralized database.

10. An access provider in a system for controlled distribution of a content acquired by a user from a content provider, wherein said access provider comprises a local database able to store data relating to the user's rights over the acquired content and a decisionmaking device able to analyze streams sent out by said user and to decide if said streams sent out conform to said rights of use of the user.

11. The access provider according to claim 10, wherein the access provider can supply information about the presence of the user at an access point to an approved presence function of a content control provider.
